(19) United States
(12) Patent Application Publication
(10) Pub. No.: US 2016/0253729 A1
(43) Pub. Date: Sep. 1, 2016

(54) COOPERATION SERVER, COOPERATION PROGRAM, AND EC SYSTEM

(71) Applicant: IPS CO., LTD., Osaka (JP)

(72) Inventor: Toshifumi AKITA, Osaka-shi (JP)

(73) Assignee: IPS CO., LTD., Osaka (JP)

(21) Appl. No.: 14/423,775

(22) PCT Filed: Jun. 23, 2014
(86) PCT No.: PCT/JP2014/003364

§ 371 Date: Feb. 25, 2015

(51) Int. Cl. G06Q 30/06; G06F 17/30

(52) U.S. Cl. CPC G06Q 30/0619; G06F 17/30377; G06F 17/30339; G06F 17/30575; G06Q 30/0643

(57) ABSTRACT

Provided is an EC system that can be easily built. A cooperation server, which cooperates an EC site and a plurality of core business systems supplying products to the EC site with each other, includes a cooperation data storage unit storing cooperation data configured based on business data transmitted from each of the core business systems including a business data storage unit storing the business data generated on business, receives business data updated content information representing an updated content of the business data from the core business system when the business data is updated by the core business system, updates the cooperation data based on the received business data updated content information, and executes a process for updating the product data such that the updated content of the business data is reflected when the cooperation data is updated.

### CROSS REFERENCE TO RELATED APPLICATIONS

The present application is a U.S. national phase application under 35 U.S.C. §371 of PCT Application No. PCT/JP2014/003364, filed on Jun. 23, 2014

### TECHNICAL FIELD

The present invention relates to a cooperation server that cooperate an EC site selling products on the Internet by referring to a product data storage means for storing data of the products with a plurality of core business systems supplying the products to the EC site, a cooperation program that is used for operating the cooperation server, and an EC system.

### BACKGROUND ART

Conventionally, systems (electronic commerce (EC) systems) relating to wholesale services of information technology (IT)-related products are known.

For example, an EC system has been disclosed which supports a wholesale business for distributing IT-related products from a manufacturer to a user on a computer and communication network and exchanging information including transaction information of the IT-related products with clients arranged at each distribution step from the user to the manufacturer through a communication means in real time (refer to Patent Literature 1).

### CITATION LIST

### Patent Literature

Patent Literature 1: JP 2001-344323 A

### SUMMARY OF INVENTION

### Technical Problem

However, in the EC system disclosed in the patent literature described above, there is a problem in that it is necessary to prepare data dedicated for the EC system such as a product database on the manufacturer side performing the service using IT-related products. In other words, there is a problem in that there is a heavy design load for building an EC system.

An object of the present invention is to provide an EC system that can be easily built by resolving the above-described problem.

### Solution to Problem

According to the present invention, there is provided a cooperation server that cooperates an EC site selling products on the Internet by referring to a product data storage means for storing data of the products and a plurality of core business systems supplying products to the EC site with each other. The cooperation server includes: a cooperation data storage means for storing cooperation data configured based on business data transmitted from each of the core business systems including a business data storage means for storing the business data generated on business; an updated content information reception means for receiving business data updated content information representing an updated content of the business data from the core business system when the business data is updated by the core business system; a first cooperation data update means for updating the cooperation data based on the received business data updated content information; and a product data update processing means for executing a process for updating the product data such that the updated content of the business data is reflected when the cooperation data is updated.

By employing the configuration described above, an EC system that can be easily built can be provided.

A second cooperation data update means for updating the cooperation data according to a content of a purchase request when the purchase request of a product is received from a user using the EC site and a purchase request information transmission means for transmitting purchase request information representing that the purchase request is received to the core business system may be configured to be further included.

The core business system may be configured to include a business data DB as the business data storage means, and the business data stored in the business data DB may be configured to be data configured by at least one or more tables, is data configured by the tables that have the same structure, and is data acquired by arranging process data representing data relating to each business process configuring a process flow in same entries of the tables.

The core business system may be configured to include at least two or more of the business data DBs and further include a replica data reception means for receiving replica data of each of the at least two or more business data DBs and a first cooperation DB update means for updating a cooperation DB as the cooperation data storage means based on data acquired by integrating the received replica data.

The first cooperation DB update means may be configured to update the cooperation DB such that data acquired by directly integrating a plurality of pieces of the received replica data is set as the cooperation data.

A second cooperation data update means for updating a cooperation DB as the cooperation data storage means such that data at least including process data corresponding to a display item displayed on the EC site is set as the cooperation data may be configured to be further included.

It may be configured such that the product data update processing means updates the product data by transmitting the business data updated content information to the EC site management server managing the EC site, and the EC site management server includes a product data storage means and an EC page generation means for generating an EC page configuring the EC site by referring to the product data storage means.

It may be configured such that a server managing the EC site is the cooperation server, and a server including the product data storage means is the cooperation server.

In addition, according to the present invention, there is provided a cooperation program used for controlling a cooperation server that cooperates an EC site selling products on the Internet by referring to a product data storage means for storing data of the products and a plurality of core business systems supplying products to the EC site with each other. The cooperation program causes the cooperation server including a cooperation data storage means for storing cooperation data configured based on business data transmitted from each of the core business systems including a business data storage means for storing the business data generated on business to execute: an updated content information reception process for receiving business data updated content information representing an updated content of the business data from the core business system when the business data is updated by the core business system; a first cooperation DB update process for updating the cooperation data based on the received business data updated content information; and a product data update process for executing a process for updating the product data such that the updated content of the business data is reflected when the cooperation data is updated.

Furthermore, according to the present invention, there is provided an EC system including: an EC site selling products on the Internet by referring to a product data storage means for storing data of the products; a plurality of core business systems supplying products to the EC site; and a cooperation server cooperating the EC site and the core business system with each other. Each of the core business systems includes a business data storage means for storing business data generated on business. The cooperation server includes: a cooperation data storage means for storing cooperation data configured based on business data transmitted from the core business system including the business data storage means; an updated content information reception means for receiving business data updated content information representing an updated content of the business data from the core business system when the business data is updated by the core business system; a first cooperation data update means for updating the cooperation data based on the received business data updated content information; and a product data update processing means for executing a process for updating the product data such that the updated content of the business data is reflected when the cooperation data is updated.

### Advantageous Effects of Invention

According to the present invention, an EC system that can be easily built can be provided.

### BRIEF DESCRIPTION OF DRAWINGS

FIG. 1 is a block diagram that illustrates an example of the configuration of an EC system according to a first embodiment.

FIG. 2 is an explanatory diagram that illustrates an example of a storage state of process flow data.

FIG. 3 is a block diagram that illustrates an example of the configuration of a cooperation server.

FIG. 4 is an explanatory diagram that illustrates an example of a storage state of transaction data.

FIG. 5 is an explanatory diagram that illustrates an example of a storage state of cooperation data.

FIG. 6 is an explanatory diagram that illustrates an example of a storage state of product data.

FIG. 7 is a conceptual diagram that illustrates the concept of an EC system.

FIG. 8 is a conceptual diagram that illustrates the concept of an EC system.

FIG. 9 is a flowchart that illustrates an example of a cooperation DB update process.

FIG. 10 is a flowchart that illustrates an example of a first update process.

FIG. 11 is an explanatory diagram that illustrates an example of a storage state of updated cooperation data.

FIG. 12 is an explanatory diagram that illustrates an example of a storage state of updated transaction data.

FIG. 13 is a flowchart that illustrates an example of a second update process.

FIG. 14 is an explanatory diagram that illustrates an example of a storage state of updated product data.

FIG. 15 is a flowchart that illustrates an example of a business data update process.

FIG. 16 is a block diagram that illustrates an example of the configuration of an EC system according to the second embodiment.

FIG. 17 is a flowchart that illustrates an example of a first update process according to the second embodiment.

FIG. 18 is a flowchart that illustrates an example of a second update process according to a second embodiment.

### DESCRIPTION OF EMBODIMENTS

### First Embodiment

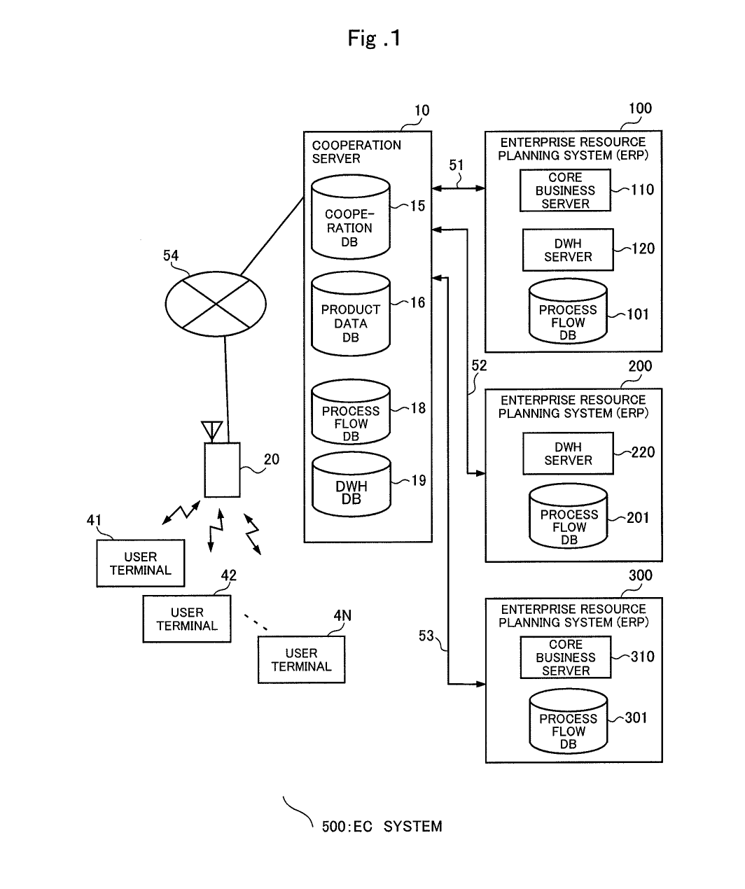

Hereinafter, a first exemplary embodiment of the present invention will be described with reference to the drawings. FIG. 1 is a block diagram that illustrates an example of the configuration of an EC system 500 according to the first embodiment of the present invention. As illustrated in FIG. 1, the EC system 500 includes a cooperation server 10, user terminals 41 to 4N (here, N is an arbitrary positive integer), and core business systems (a system enterprise resource planning systems 100 and enterprise resource planning systems 200 and 300).

The cooperation server 10 is connected to the enterprise resource planning systems 100, 200, and 300 and the user terminals 41 to 4N through communication networks 51, 52, 53, and 54 such as local area networks (LAN) or dedicated communication lines. The cooperation server 10 of this example is a server used for cooperating an EC site that sells products on the Internet by referring to a product data storage unit storing data of the products with a core business system supplying the products to the EC site. The cooperation server will be described later in detail.

The enterprise resource planning system 100 includes a core business server 110, a data warehouse server (DWH server) 120, a cooperation program database (DB) 130, and a process flow DB 101. In addition, the enterprise resource planning system 200 includes a DWH server 220, a cooperation program DB 230, and a process flow DB 201. The enterprise resource planning system 300 includes a core business server 310, a cooperation program 330, and a process flow DB 301.

A plurality of the enterprise resource planning systems 100, 200, and 300 having mutually-different configurations communicate with a predetermined server operated by an ERP as is necessary (in other words, according to the functions included in each system), thereby exhibiting the function of the enterprise resource planning system. In other words, in the EC system 500, also the system 200 not including a core business server or the system 300 not including a DWH server can exhibit the function of the enterprise resource planning system by communicating with a predetermined server operated by the ERP. In addition, in the EC system, the predetermined server operated by the ERP may be configured to be included in each of the enterprise resource planning systems 200 and 300. In each core business system (for example, the enterprise resource planning systems 100, 200, and 300), constituent elements having the same name have the same configuration, and thus, the enterprise resource planning system 100 including constituent elements common to all the systems among the enterprise resource planning systems 100, 200, and 300 will be described as an example.

Here, the core business server 110 and the DWH server 120 are assumed to be connected through a dedicated communication line.

The core business server 110, for example, is a server that is managed by a supervisor of the enterprise resource planning system 100, has various functions for managing (for example generation, update, storage, and the like of information) form information relating to various businesses. The core business server 110 is configured by a general information processing apparatus that includes an operating system (OS) and a relational DB.

Here, a form is data generated in a business and a general term of an account book and a slip. In an account book, items relating to receipts and disbursements of money and products are written, and a slip is source data for generating an account book and is a proof of a business transaction or the like. In this example, a case will be described in which the core business server 110 handles process data representing only slip data as the form data.

The core business server 110 performs various processes in accordance with a business application program. As examples of the business application program, there are a sales business management program, a purchase business management program, a production management program, a financial accounting management program, and a managerial accounting management program.

The DWH server 120, for example, is a server that is managed by a system supervisor of this system and has various functions for implementing a data warehouse. Here, a data warehouse represents a system analyzing the relevance between items of the business data such as form data accumulated in a time series. In addition, the DWH server 120 has a function for converting a file in the CSV format transmitted from the core business server 110 into a predetermined data format or the like and registering various kinds of data in a predetermined storage area (a business-related data DB 101b to be described later). Furthermore, the DWH server 120 may be configured not to convert the data format but to extract data corresponding to each storage area from the state of the comma separated values (CSV) format.

The cooperation program DB 130 is a DB in which a cooperation program used for executing a process for reflecting update information on the entire EC system in real time is stored. Here, as processes that are executed according to the cooperation program, for example, there are a process of receiving data transmitted from the EC system cooperation server 10, a process of receiving data input to a web page of an EC site (not illustrated in the figure) not belonging to the EC system 500, a process of updating the process flow data stored in the process flow DB 101 based on received data, a process of notifying the EC system cooperation server 10 that the process flow data has been updated, a process of transmitting a shipment instruction to a terminal (not illustrated in the figure) managed by a delivery company, a process of receiving a shipment record from a terminal managed by a delivery company, and the like.

In addition, while not particularly illustrated in the figure, the enterprise resource planning system 100 of this example includes a stock information storage unit storing stock information that is calculated based on information relating to incoming/outgoing stock that is included in the process flow data. The stock information of this example includes an item ID that can be used for uniquely specifying a product, an actual stock quantity, and an order-in-process quantity. Here, the “actual stock quantity” is information that represents an actual stock. In addition, the “order-in-process quantity” is information that represents a quantity before shipping out of an ordered quantity.

The process flow DB 101 is a storage medium storing business data that is configured by various kinds of process data (or form data) collected, arranged, or the like by various kinds of information processing using various programs stored in an application program DB (not illustrated in the figure) of the core business server 110. In this example, a case will be described as an example in which process flow data is handled as the business data. Thus, hereinafter, there are cases where the business data may be referred to as process flow data.

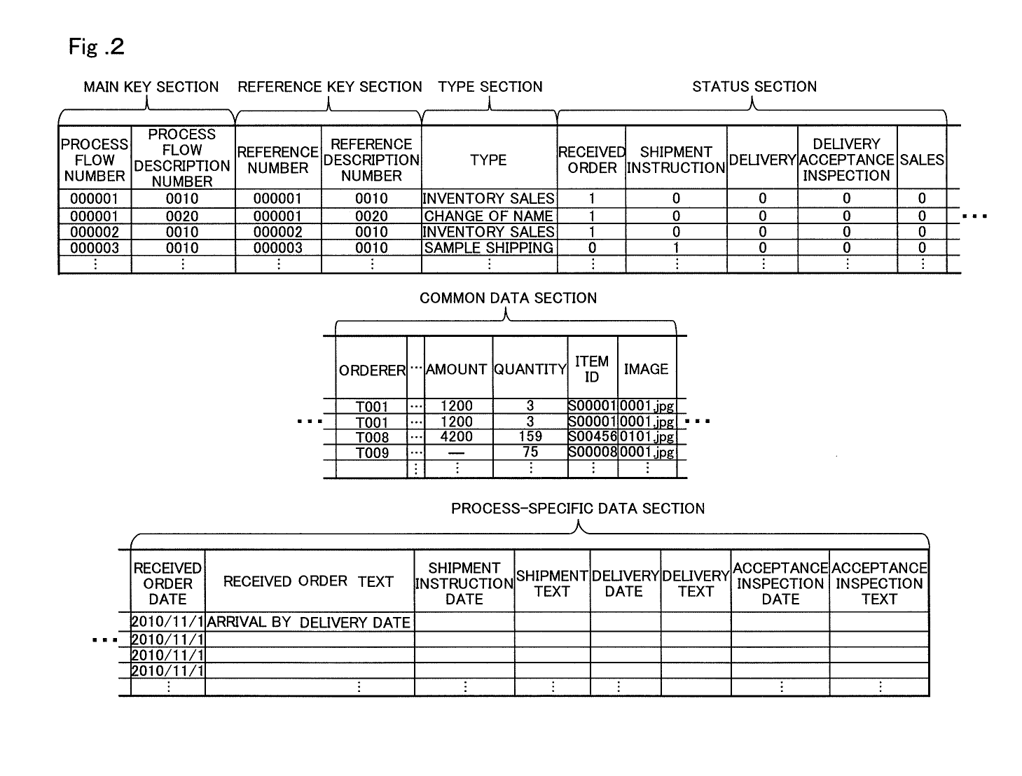

FIG. 2 is an explanatory diagram that illustrates an example of a storage state of the process flow data included in the process flow DB 101. As illustrated in FIG. 2, in this example, the process flow data is configured by at least one or more tables and includes a main key section, a reference key section, a type section, a status section, a common data section, and a process specific data section. Here, an item (in other words, each column item in the process flow table) corresponding to each section of the process flow data represents the type of the process data configuring the process flow data. In other words, data (process data) relating to each business process configuring the process flow is stored with being assigned to each section (each item) configuring the process flow data.

In addition, in the system 500 of this example, a case will be described as an example in which data configured by using at least one or more tables, configured by the tables that have the same structure, and acquired by arranging data relating to one process flow in the same entries of the tables is used as the process flow data.

In this example, the data stored as the process flow data becomes a base for data relating to a product or a service that is a target for an electronic commerce. In other words, in this example, the process flow data stored in the process flow DB 101 is used as a base of product data of the EC system 500.

The process data relating to one process flow (for example, a series of process flows from received order from a company to delivery) is stored in the same entry (in other words, the same row in the process table PT) in the process flow table. In other words, the process flow data has a structure in which data relating to one process flow is arranged in the same entry of the process flow table. According to such a configuration, a correspondence relation among the process data can be defined.

Here, the “main key section” is a part, in which main key data that is data used for uniquely specifying the process flow data among the process flow data is stored, of the process flow data. In this example, the main key section is configured by a process flow number and a process flow description number. In other words, in this example, a combination of a process flow number and a process flow description number becomes an identifier (ID) of each process flow data. The main key section is updated at a time when the process flow data is registered for the first time. Here, “a time when the process flow data is registered for the first time” represents, for example, a time when process data, which belongs to a specific process flow, having a corresponding other process data that has not been registered is registered. In addition, the “update” described here includes the addition of data.

In addition, the “process flow number” is an identifier used for specifying one piece of the process flow data (in other words, one column of the process flow table illustrated in FIG. 2). The process flow number is assigned to each process data of which a predetermined item is the same. In this example, the same process flow number is assigned to the process flow data having the same type and the same orderer among the process flow data.

Furthermore, the “process flow description number” is an identifier used for specifying specific process flow data among the process flow data to which the same process flow number is assigned. In other words, for example, in the process flow table illustrated in FIG. 2, in the business process “received order” in the type “inventory sales” of the process flow, process flow data including process data representing the received order of the business of the amount of money “1200” or “2600” from an orderer “T001” can be uniquely specified using a combination of a process flow number “000001” and a process flow description number “0010” or “0020”.

Next, the “reference key section” is a part in which reference key data, which is data used for specifying another process flow data (or another process data) relating to the process flow such as an original transaction of sales return among the process flow data, is stored. In this example, the reference key section is configured by a reference number and a reference description number. The reference key section is updated when the process flow data is registered for the first time.

In addition, in the reference number and the reference description number, a process flow number and a process flow description number of another process flow relating to the process flow are stored. However, in a case where there is no other process flow relating to the process flow as in the case of a new transaction, data (in other words, the process flow number is stored in the reference number, and the process flow description number is stored in the reference description number) representing the same values as those of the main key section of the same entry is stored. In addition, in a case where the reference key section represents another process data relating to the process flow, data used for specifying the type of the process data is further disposed in the reference key section.

Furthermore, the “type section” is a part in which type data, which is data representing the type of the process flow such as inventory sales or sample shipping, among the process flow data is stored. The type section is updated when the process flow data is registered for the first time. Here, the kinds of the process flows are not limited to the inventory sales and the sample shipping. In addition, it is assumed that processes required for each process flow are determined in advance (in other words, the types and the number of business processes included for each process flow are different). A plurality of the other types of the process flow will be presented later.

The “status section” is a part in which status data, which is data (in other words, data representing the progress statuses of a plurality of business processes included in the process flow) representing the progress of the process flow among the process flow data, is stored. In this example, the status data is set to “0” for an unsettled business process that is needed in the process flow and is set to “1” for a settled business process, thereby representing the progress of each business process. In other words, for example, as illustrated in FIG. 2, in a process flow of the “inventory sales”, in a case where the business processes included in the process flow are “received order”, “shipment”, “delivery”, “delivery acceptance inspection”, and “sales”, it is assumed that process specific data (for example, received order date) relating to the business process “received order” is registered. In such a case, in the status data, a part corresponding to the “sales” is “1”, and the other parts are maintained to be in the initial states (in other words, a state in which “0” is set).

In this example, the status section is updated for each business process. In other words, when process specific data to be described later is input, the status section is updated when each business process is determined to be completed based on the satisfaction of a predetermined status change condition. Here, although the status change condition is not particularly limited, in this example, it is assumed that “all the process specific data corresponding to one business process is input” is stored in a predetermined storage area of the enterprise resource planning system 100 as the status change condition.

In this example, since process flows of different types are stored in the same table, there are cases where a portion in which unnecessary process data is stored is generated in a specific process flow among items (column items) configuring the table. In such a case, in the process flow table, the portion in which unnecessary data is stored stores vacant data, and, in the status data corresponding to the vacant data, “0” is assumed to be stored.

In addition, the “common data section” is a part storing common data that is data (in other words, data that is common to business processes included in the same process flow) not depending on a business process such as an orderer or a shipping destination among the process flow data. The common data section is updated when the process flow data is registered for the first time. The “common data section” of this example includes an item ID used for uniquely specifying a product, a quantity, and an image representing the product.

The “process specific data section” is a part storing the process specific data that is data specific to each business process included in the same process flow such as received order date or data (for example, text data representing precautions such as “arrival by delivery date” or “fragile goods (attention: fragile goods)” registered in each business process among the process flow data. The process specific data section is updated for each business process. Accordingly, in this example, among the process flow data, data that depends on a business process is the “process specific data” and data that does not depend on a business process is the “common data”.

While the process flow data of this example has been described as above, the definitions of various terms represented in FIG. 2 will be simply described.

First, the “received order” represents a state in which an order is received from a customer and a contract with the customer is made. In other words, in this example, the “received order” represents a state that includes not only a case where an order is received from a general customer but also a case where an order is received from a user using the EC site.

In addition, the “shipment instruction” represents a state in which an instruction for shipping a product is made for a warehouseman or a distribution staff. In other words, in this example, the “shipment instruction” represents a state in which a shipment instruction is made for a product that is purchased by a user who has purchased the product at the EC site.

The “delivery” represents a state in which a product is shipped from the warehouse and starts to be transferred. In other words, in this example, the “delivery” represents a state in which a product purchased by a user using the EC site is shipped from a warehouse.

In addition, the “acceptance inspection” represents a state in which the acceptance inspection is completed by the customer, and the ownership of the product is changed over to the customer.

The “sales” represents a state in which the customer's acceptance inspection is checked, and the amount of claims for the customer is finalized (the claims are accounted).

In addition, the term “acceptance inspection” is used to represent an “operation of inspecting whether or not a supplied product or service has the specifications (the quantity, the color, the shape, and the quality as ordered) as ordered” or the “transition of ownership of assets at the time of completion of the acceptance inspection” as well. In addition, in financial accounting (or institutional account) or on an ERP system, in order to clarify the transmission timing of the ownership of the assets, an event of “acceptance inspection” is defined to be differently from the delivery.

Furthermore, in this example, it is assumed that slip data (for example, for slip data corresponding to an received order slip, data that is associated with received order slip header information, received order slip specification information, delivery date and schedule, and the like and is stored in a structure that is searchable based on a key such as a slip number or the like; an received order number, a purchase order number, a shipment number, a storage and retrieval number, an invoice inquiry, a billing number, an accounting number, and the like are included in the slip number) that is generally used is included in the process flow data.

In the EC system 500 of this example, as described above, the process flow data is configured to be managed by one process flow table. However, the configuration is not limited to such a configuration, a configuration may be employed in which the core business system (for example, the enterprise resource planning system 100) manages the process flow data, for example, using a plurality of tables for each type to be described later or for each data of which a part (for example, an orderer or the like) of the content of the common data to be described later is the same.

The cooperation server 10 is a server that is used for cooperating an EC site managed thereby with core business systems (the enterprise resource planning systems 100, 200, and 300). The cooperation server 10, for example, is configured by an information processing apparatus such as a WWW server and is managed by a supervisor of the EC system 500 or the like.

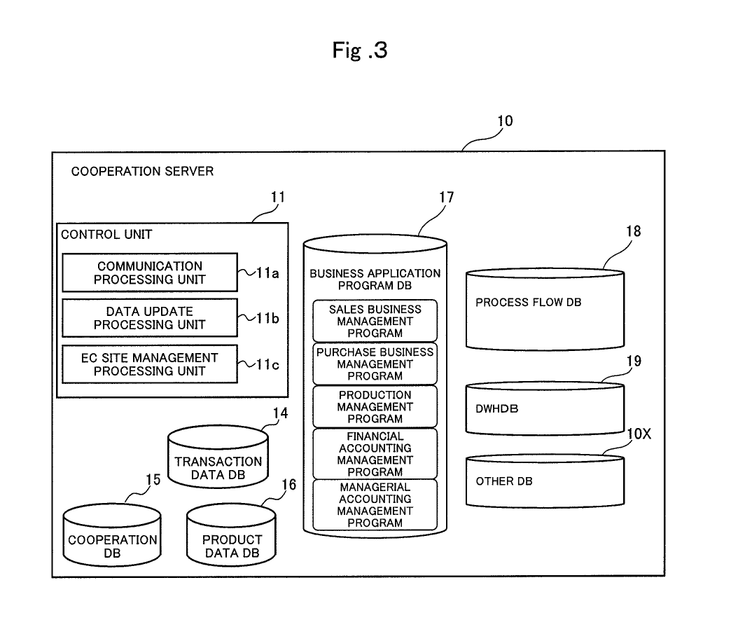

FIG. 3 is a block diagram that illustrates an example of the configuration of the cooperation server 10. As illustrated in FIG. 3, the cooperation server 10 includes a control unit 11 that performs various kinds of control, a transaction data DB 14, a cooperation DB 15, a product data DB 16, a business application program DB 17, a process flow DB 18, a DWH DB 19, and the other DB 10X that stores various kinds of data (for example, data used by various programs stored in the business application program DB 17) that is necessary for realizing functions of a general core business server.

The control unit 11 includes a communication processing unit 11a, a data update processing unit 11b, a cooperation DB update processing unit 11c, and an EC site management processing unit 11d. Each processing unit included in the control unit 11 performs each process based on a program stored in the business application program DB 17.

The communication processing unit 11a has a function for executing a process of transmitting data used by the EC system 500 to other terminals, a process of receiving the data from other terminals, and the like.

The data update processing unit 11b has a function for executing a process of updating data used by the EC system 500. More specifically, the data update processing unit 11b executes a process of adding/removing data, a process of writing data in a predetermined recording area, and the like.

The EC site management processing unit 11c executes a process used for causing the cooperation server to serve as an EC site management server that manages the EC site. More specifically, the EC site management processing unit 11c has a function for executing a process of receiving a product purchase request from a user using the EC site, a process of updating cooperation data based on the content of the purchase request, a process of transmitting purchase request information representing that the purchase request has been received to the core business system, and the like.

The transaction data DB 14 is a storage medium that stores transaction data including purchase request information that is transmitted from the user terminals 41 to 4N. The transaction data is data that configures the EC site.

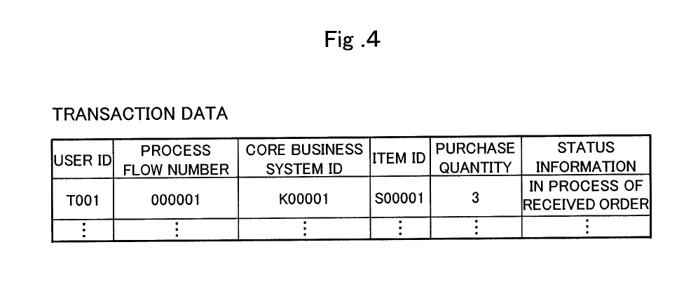

FIG. 4 is an explanatory diagram that illustrates an example of a storage state of transaction data that is stored in the transaction data DB 14. As illustrated in FIG. 4, the transaction data is information that is stored when purchase request information is received from the user terminals 41 to 4N and includes a user ID, a process flow number, a core business system ID, an item ID, a quantity, and status information. In addition, the status information is “in process of received order” when data is added (in other words, when a purchase request is received) and then is appropriately updated according to the progress status of the process (for example, updated to “shipping completed” or the like).

Here, the core business system ID is ID information used for specifying a core business system that is a product supply source. For example, for a product provided by the enterprise resource planning system 100, an identifier “K0001” is stored.

The cooperation DB 15 is a storage medium that stores cooperation data used for cooperating the EC site and the core business systems (the enterprise resource planning systems 100, 200, and 300) with each other.

Here, the cooperation data is the process flow data that is transmitted from the core business systems (for example, the enterprise resource planning systems 100 and 200). In this example, while the cooperation server 10 is configured to include one cooperation DB 16, a plurality of DBs in which each replica data is stored may be configured to be arranged.

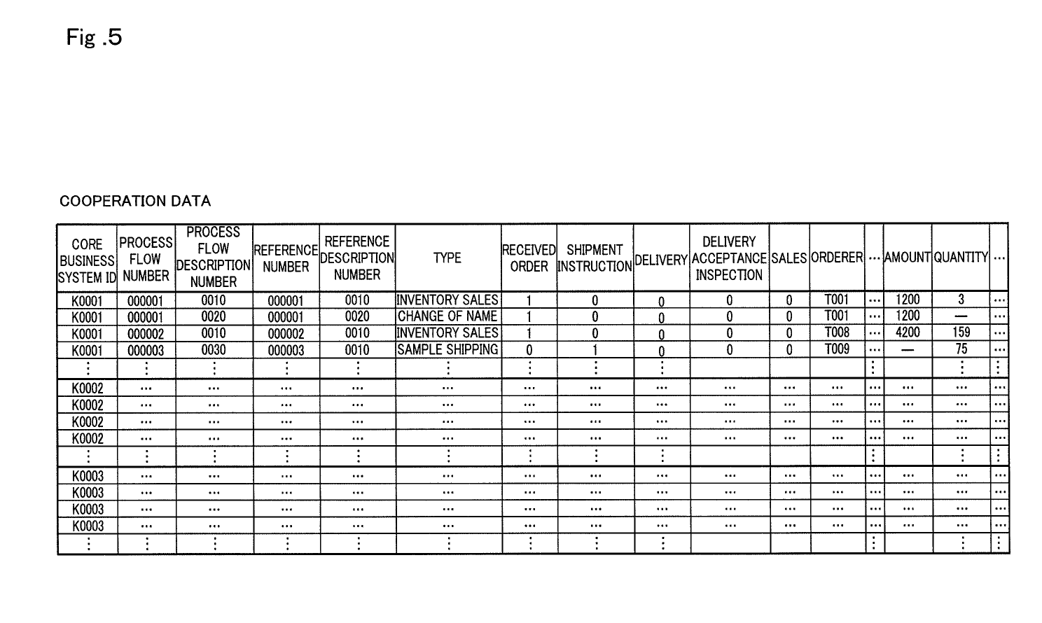

FIG. 5 is an explanatory diagram that illustrates an example of a storage state of the cooperation data stored in the cooperation DB 15. In this example, since the process flow data is directly integrated as cooperation data without changing the configuration of the process flow data, the cooperation data has the same configuration as the process flow data that is stored in the process flow DB 101 described above.

The product data DB 16 is a storage medium that stores product data used for configuring the EC site.

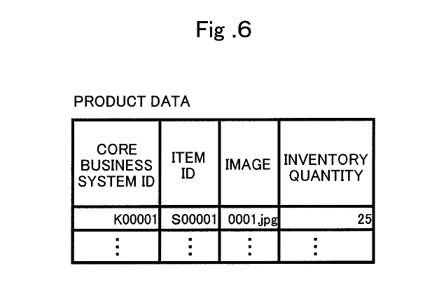

FIG. 6 is an explanatory diagram that illustrates an example of a storage state of product data that is stored in the product data DB. As illustrated in FIG. 6, the product data is data that configures the EC site and includes a core business system ID, an item ID, an image, and a stock quantity.

Here, the stock quantity is information that represents the quantity of the stock of products. The stock quantity managed here is updated by the EC site management processing unit 11d when the cooperation server 10 receives orders from the user terminals. More specifically, the stock quantity may be rewritten as a numerical value that is acquired by subtracting the number of accepted orders from the current stock quantity.

The business application program DB 17 is a storage medium that stores programs used for various businesses. The business application program DB 17, for example, stores various programs such as a sales business management program, a purchase business management program, a production management program, a financial accounting management program, a managerial accounting management program, a data update processing program, and a data transmission/reception processing program.

The process flow DB 18 is a storage medium that stores process flow data configured by various kinds of process data (or form data) that is collected and arranged by various information processes using various programs stored in the business application program DB 17. The process flow data stored in the process flow DB 18 is generated based on information (for example, process flow data) transmitted from each core business system.

In this example, the cooperation server 10 is configured to have a function for providing various kinds of data stored in the process flow DB 18 and the other DB 10X in response to requests from predetermined external apparatuses (for example, the enterprise resource planning systems 100, 200, and 300). Thus, the cooperation server 10 has the functions of the core business server. In other words, the cooperation server 10 includes an ERP engine.

In addition, although not illustrated in the figure, in this example, the cooperation server 10 is assumed to have a function as a DWH server having various functions for realizing a data warehouse. By including the ERP engine and the configuration for the function of the DWH server, the cooperation server 10 may be configured to provide information requested as an enterprise resource planning system also for the enterprise resource planning systems (for example, the enterprise resource planning system 100 having both the core business server and the DWH server, the enterprise resource planning system 200 having only the DWH server, and the enterprise resource planning system 300 having only the DWH server) having mutually different configurations.

Each of the user terminals 41 to 4N is an information processing apparatus such as a mobile terminal or a personal computer (PC) including a central processing unit (CPU), a ROM, a RAM, a display unit, and the like. Here, an electronic commerce partner assumed as a user includes not only a final consumer but also a company, a public organization, and the like.

Each of the user terminals 41 to 4N communicates with the cooperation server 10 through a repeater 20 and a communication network 54. In addition, each of the user terminals 41 to 4N includes a storage medium that stores various applications capable of reading an EC page such as a web browser and the like. Each of the user terminals 41 to 4N has a function for acquiring product data from the cooperation server 10 and displaying the acquired product data and the like, for example, in response to a user's operation input.

Next, the concept of the EC system 500 (hereinafter, may be referred to as a system 500) of this example will be described with reference to the drawing.

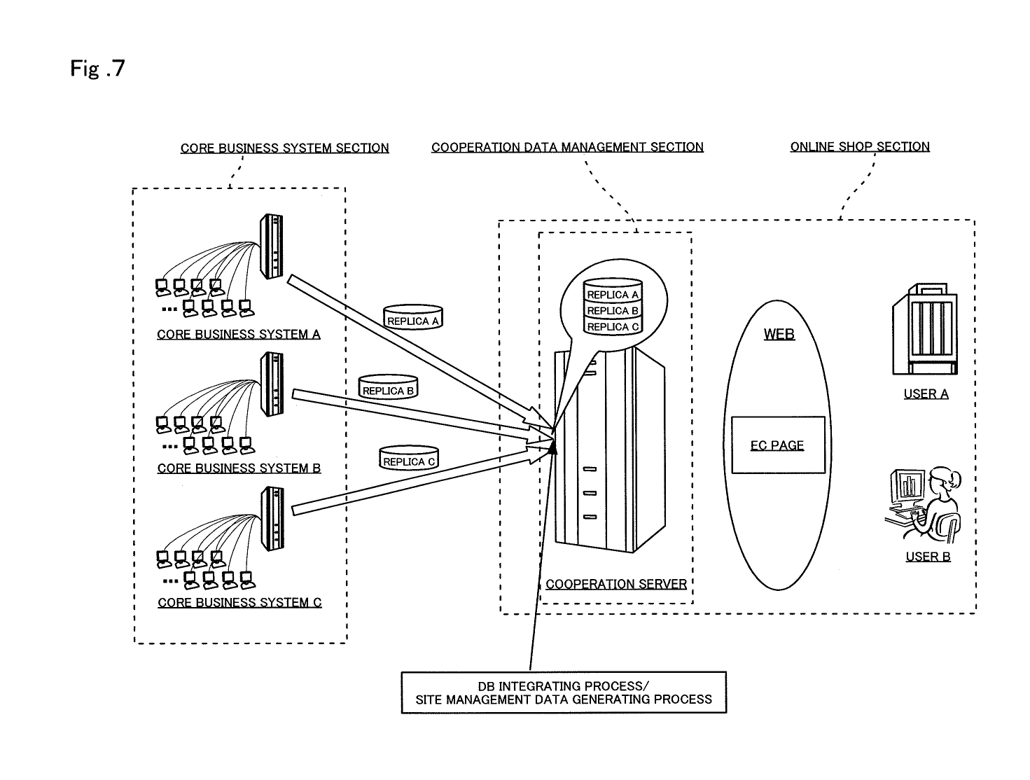

FIG. 7 is a conceptual diagram that illustrates the concept of the EC system of this example. More specifically, FIG. 7 is a conceptual diagram that illustrates the flow in which the basic configuration is built. As illustrated in FIG. 7, the EC system may be largely divided into three sections. More specifically, the EC system is configured by: an online shop section that sells products or services; a plurality of core business system sections (core business systems A, B, and C) that manage data generated in the business; and a cooperation data management section that cooperates the online shop section and the core business system section with each other. Here, the online shop section and the cooperation data management section are configured by one server.

In the EC system of this example, first, each core business system generates a replica of a DB thereof and transmits the generated replica to the cooperation server. The cooperation server manages a plurality of received DBs of the core business systems as one DB (see “DB integration process” illustrated in FIG. 7). Then, the cooperation server manages the plurality of DBs as one DB. In addition, the cooperation server generates site management data used for managing the EC site based on the integrated DB and stores the generated site management data in the DB. This site management data serves as a product master. In this way, the basic configuration of the EC system directly using the DBs managed by the plurality of core business systems is built.

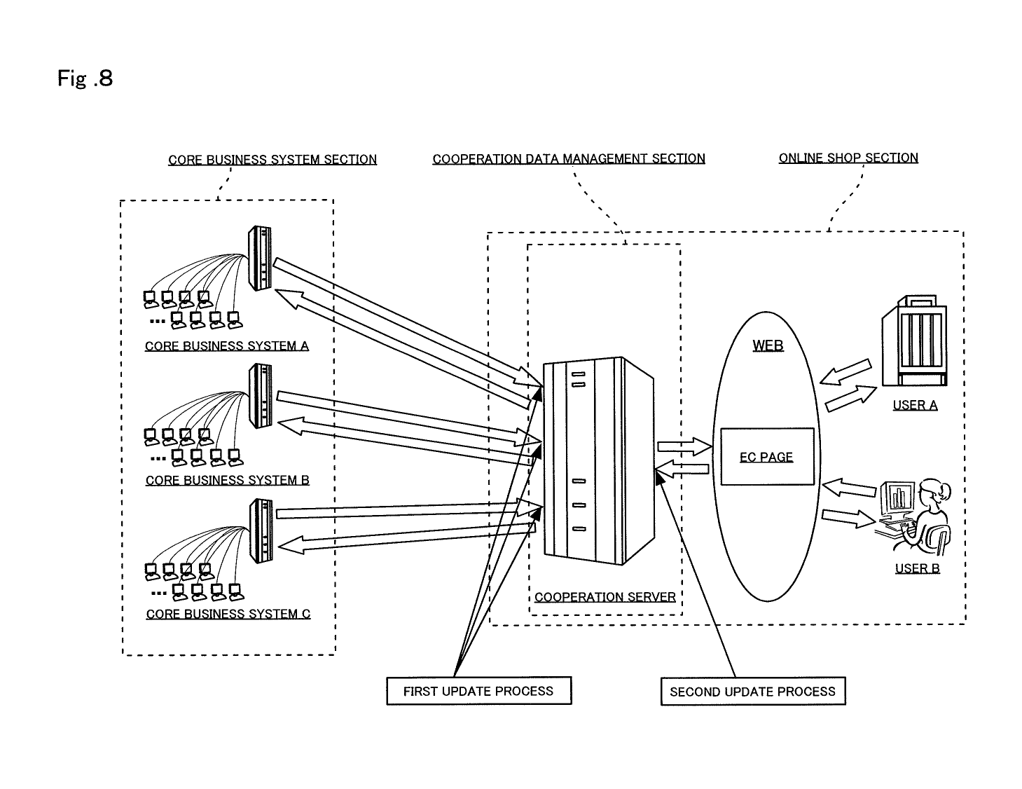

FIG. 8 is a conceptual diagram that illustrates the concept of the EC system of this example. More specifically, FIG. 8 is a conceptual diagram that illustrates the flow of the process executed for handling real-time information in the EC site. In the EC system having the basic configuration as illustrated in FIG. 7, when information is updated in the core business system section, the updated content is transmitted to the cooperation server. The cooperation server updates the site management DB based on the transmitted information (see “first update process” illustrated in FIG. 8). For example, in the core business system, when stock data of a product changes according to the generation of the shipping process, the change is notified to the cooperation server and the site management server, and information relating to the change is reflected in real time.

Meanwhile, in the online shop section, when a product (or service) purchase request is received, the content of the purchase request is transmitted to the cooperation server. The cooperation server updates the DB based on the transmitted information (see the “second update process” illustrated in FIG. 8). Then, the cooperation server transmits the content of the update to the core business system side. At this time, the DB is updated based on the content of the purchase request in the core business system section, and a result of the update is notified to the cooperation server. Then, the cooperation server notified of the update updates the site management DB based on the content of the notification of the update.

As described above, the EC system can manage data managed by each of the plurality of core business systems as one DB in a simple manner. In addition, the data managed by the core business system, a part of the data managed by the cooperation server, and the data used by the EC site are synchronized with each other in almost real time. In this way, the EC system can realize an electronic commerce by employing a simple configuration and can provide a place of an electronic commerce in which update information of the system can be reflected on the entire EC system in real time.

Next, the operation of the system 500 of this example will be described with reference to the drawing. Here, the contents of operations and processes not particularly relating to the present invention may not be presented.

First, a cooperation DB update process executed by the cooperation server 10 of the system 500 of this example will be described.

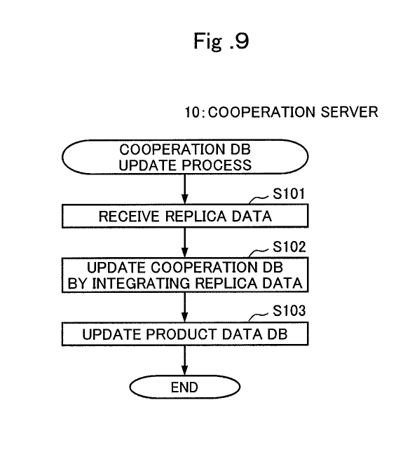

FIG. 9 is a flowchart that illustrates an example of the cooperation DB update process executed by the cooperation server 10 of the system 500 of this example. Here, a case will be described as an example in which there are a plurality of core business systems (for example, companies or predetermined groups inside a company) included in the EC system 500. In addition, a case will be described as an example in which data transmitted from the plurality of core business systems is integrated as one piece of data.

In the cooperation DB update process, first, the cooperation server 10 receives replica data of a DB from each of the core business systems (the enterprise resource planning systems 100, 200, and 300) included in the EC system in step S101. In this example, three DBs are received. More specifically, the cooperation server 10 receives replica data of the process flow DB 101 from the enterprise resource planning system 100. In addition, the cooperation server 10 receives replica data of the process flow DB 201 from the enterprise resource planning system 200. Furthermore, the cooperation server 10 receives replica data of the process flow DB 301 from the enterprise resource planning system 300. Here, the data received in step S101 includes a core business system ID used for uniquely specifying the core business system that is a transmission source.

In the system 500 of this example, while replica data of the DB stored in the core business system 100 is configured to be transmitted, the core business system 100 may be configured to extract data required for configuring an EC site and transmit the extracted data.

When the replica of the DB is received from each core business system, the cooperation server 10 integrates the received replica data into one piece of data and updates the cooperation DB based on the integrated data in step S102. As described above, in this example, the process flow data stored in each of the three DBs that have been received is data configured by at least one or more tables, is data configured by tables that have the same structure, and is data acquired by arranging data relating to one process flow in the same entries of the tables. Thus, the cooperation server 10 can generate cooperation data by directly integrating the replica data of the DBs. According to such a configuration, since the number of tables included in the process flow data can be suppressed to be minimal, the amount of data required for building the EC site can be reduced. In a case where an EC system that handles a plurality of pieces of process flow data stored in the core business systems as in this example is to be built, the EC system can be built by employing a simple configuration.

In this example, the cooperation server 10 is configured to generate one cooperation DB 15 by receiving the replica of the DB managed by each core business system from each of the plurality of core business systems included in the EC system. However, the system 500 of this example is not limited to such a configuration. For example, the cooperation server 10 may be configured to generate one cooperation DB based on a plurality of DBs by receiving replica data of each of the plurality of process flow DBs included in one core business system. In addition, the cooperation server 10 may be configured to generate one cooperation DB by receiving replica data of one process flow DB included in one core business system.

In addition, in a case where a cooperation DB is to be built, based on received process flow data, data relating to items corresponding to display items displayed on the EC site is extracted from among data relating to the process flow, and the cooperation DB having a structure in which the extracted data is arranged in the same entries may be configured to be built. More specifically, the cooperation server 10 may be configured to include a storage unit that includes data representing display items displayed on the EC site and to extract data relating to items corresponding to the display items displayed on the EC site from among the data relating to the process flow by referring to the data included in the storage unit.

In addition, in a case where the cooperation DB is updated as being integrated as one piece of data, the cooperation server 10 updates the product data DB based on the cooperation data in step S103. In other words, the product data used for configuring the EC site is generated based on the cooperation data. More specifically, data corresponding to predetermined items (for example, an item ID, a core business system ID, a stock quantity, and a status) included in the cooperation data is extracted, and each extracted item is stored in the product data DB.

When the product data DB is updated, the cooperation server 10 ends the cooperation DB update process.

Next, an example of a first update process that is executed by the cooperation server 10 in the system 500 of this example will be described. In the first update process, a process of reflecting an updated content of the process flow data on the EC site is executed.

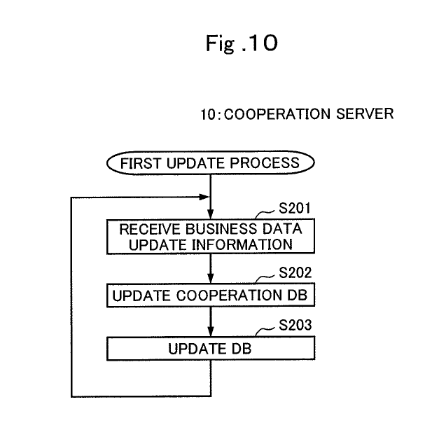

FIG. 10 is a flowchart that illustrates an example of the first update process executed by the cooperation server 10 in the system 500 of this example. In the first update process, while various kinds of data is transmitted from each core business system, in the first update process to be described below, a case will be described as an example in which data is transmitted from the enterprise resource planning system 100, and the transaction data illustrated in FIG. 4, the cooperation data illustrated in FIG. 5, and the product data illustrated in FIG. 6 are updated. In this example, while the cooperation server 10 is operated, the process is assumed to be looped.

In the first update process, first, the cooperation server 10 receives business data update information (process flow data update information) representing that the enterprise resource planning system 100 has updated the process flow DB 101 from the enterprise resource planning system 100 in step S201. Here, the business data update information includes the added table and a core business system ID representing the enterprise resource planning system 100 that is a transmission source. Here, the business data update information including process flow data in which a core business system ID is “K00001”, “shipment” is “1”, “Item ID” is “S00001”, and “Orderer” is “T001” will be described as an example.

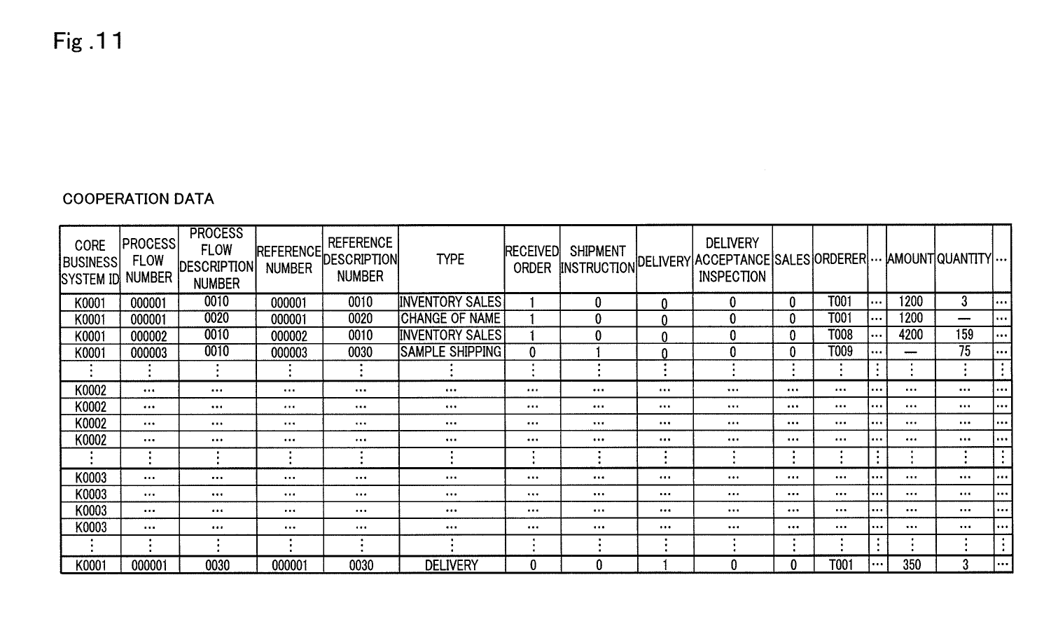

When the business data update information is received, the cooperation server 10 updates the cooperation DB 15 based on the received business data update information in step S202. More specifically, a new table as data received in step S201 is added to a lowermost part of the cooperation data illustrated in FIG. 5. In other words, the cooperation data illustrated in FIG. 5 is updated with the cooperation data illustrated in FIG. 11.

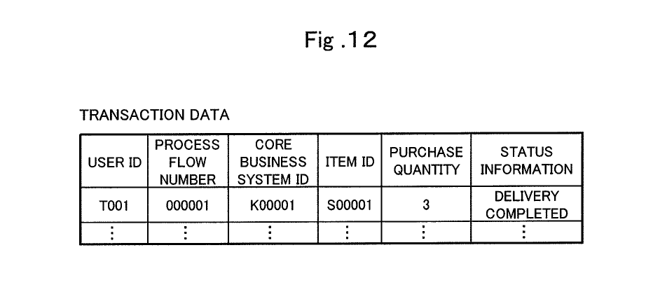

When the cooperation DB 15 is updated, the cooperation server 10 updates the DB based on the updated content in step S203. In other words, by referring to the status section included in the updated cooperation data, information (DB) to be changed and a change to be made therein are determined, and the product data DB is updated according to the determination. As illustrated in FIG. 11, in this example, since the status of the added table is “shipment”, by referring to the “orderer” included in the added table, “T001” is specified, and transaction data for changing the status to “shipment” is specified. Then, as illustrated in FIG. 12, the status of the specified part is changed from “in process of received order” to “shipping completed”. In other words, the transaction data illustrated in FIG. 4 is updated to the transaction data illustrated in FIG. 12.

When the DB is updated, the cooperation server 10 proceeds to step S201 and waits until the business data update information is received.

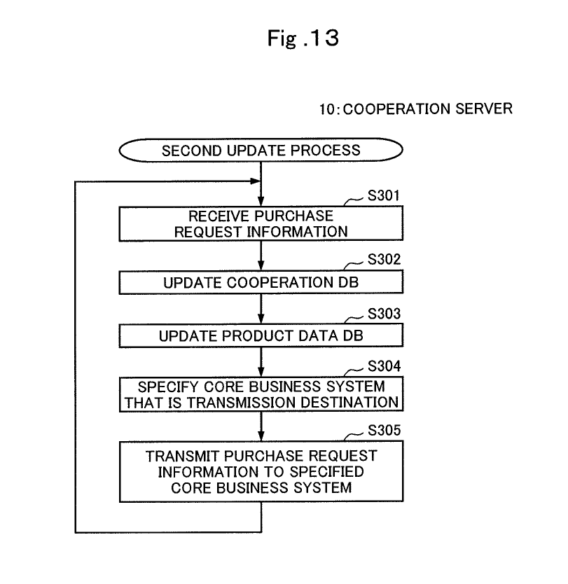

Next, an example of a second update process executed by the cooperation server 10 in the system 500 of this example will be described. FIG. 13 is a flowchart that illustrates an example of the second update process executed by the cooperation server 10 in the system 500 of this example. In the second update process, while a product purchase request is transmitted from one of the user terminals 41 to 4N, in the second update process described hereinafter, a case will be described as an example in which a product purchase request is transmitted from the user terminal 41. In this example, while the case where a product purchase request is transmitted will be described as an example, a reading request for reading information relating to the shipment status of a product or the like may be configured to be transmitted. In this example, while the cooperation server 10 is operated, the process is assumed to be looped.

In the second update process, first, the cooperation server 10 receives the purchase request from the user terminal 41 in step S301.

When the purchase request information is received, the cooperation server 10 stores the purchase request information in the transaction data DB 14 and updates the cooperation DB 15 in step S302. More specifically, a new table, to which a process flow description number is assigned based on the process flow number included in the purchase request information, is added, and other information included in the purchase request information such as a core business system ID is stored in the new table.

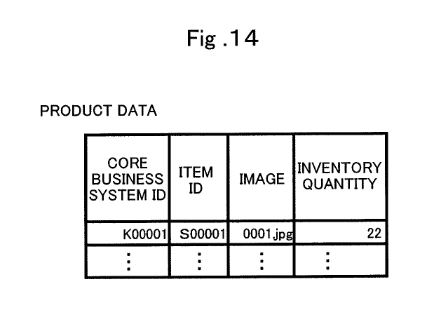

When the cooperation DB 15 is updated, the cooperation server 10 updates the product data DB 16 in step S303. More specifically, product data to be updated is specified based on the core business system ID and the item ID. More specifically, in the product data, data having the same core business system ID and the same item ID as those represented in the purchase request information is specified, and a stock quantity of the specified data is decreased by a purchase quantity. For example, in a case where the product data illustrated in FIG. 6 is stored, when purchase request information in which the “core business system ID” is “00001”, the “item ID” is “S00001”, and the “purchase quantity” is “3” is received, as the product data illustrated in FIG. 14, the “stock information” is updated from “25” to “22”.

When the product data DB 16 is updated, the cooperation server 10 specifies a core business system corresponding to the purchase request information in step S304. In other words, a core business system that is the supply source of the product is specified. Here, the corresponding core business system represents a core business system that has transmitted replica data corresponding to the information transmitted from the user terminal to the cooperation server 10 in step S101 described above.

When the core business system corresponding to the purchase request is specified, the cooperation server 10 transmits the purchase request information to the specified core business system in step S305. In the system 500 of this example, while the purchase request information is configured to be transmitted to the enterprise resource planning system 100, the table added in step S302 may be configured to be transmitted.

When the purchase request information is transmitted, the cooperation server 10 proceeds to step S301 and waits until purchase request information is received.

Next, an example of a business data update process executed by the core business system (the enterprise resource planning systems 100, 200, and 300) in the system 500 of this example will be described. In the business data update process of this example, a case will be described as an example in which the enterprise resource planning system 100 among the core business systems executes the process.

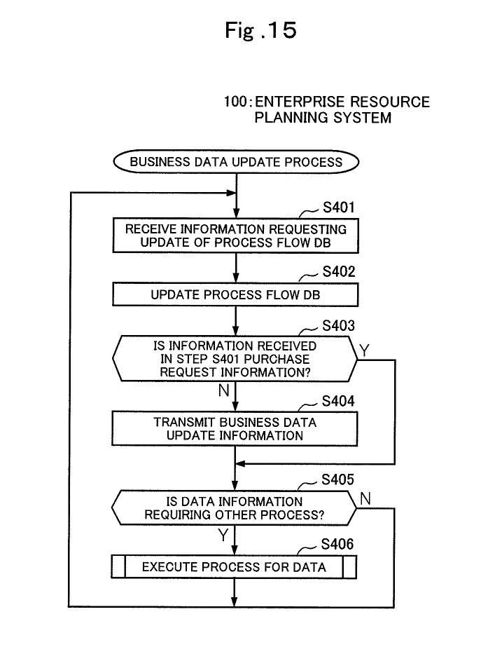

FIG. 15 is a flowchart that illustrates an example of the business data update process executed by the enterprise resource planning system 100 in the system 500 of this example. The business data update process of this example is executed by a cooperation program included in the cooperation program DB 130. In addition, in the business data update process, a process of transmitting predetermined data to the cooperation server 10, a terminal managed by the delivery company, or the like by being triggered upon the reception of information requiring an update of the process flow data is executed. In this example, while the core business system 100 is operated, the process is assumed to be looped.

In the business data update process, first, the enterprise resource planning system 100 receives information requiring an update of the process flow DB 101 in step S401. The data received here, for example, includes the purchase request information representing that there has been a product purchase request transmitted from the cooperation server 10, new process flow data (in other words, the first column in the process flow table illustrated in FIG. 2) that is input according to a direct input from a supervisor of the enterprise resource planning system 100, process flow data relating to a shipment record transmitted from a terminal managed by a delivery company, and the like.

When the information requiring an update of the process flow DB 101 is received, the enterprise resource planning system 100 updates the process flow DB 101 based on the input data in step S402. More specifically, a new table, to which a process flow description number has been assigned based on the process flow number included in the purchase request information, is added, and other information included in the purchase request information such as a core business system ID is stored in the new table.

When the process flow DB 101 is updated, the enterprise resource planning system 100 determines whether or not the process flow DB 101 has been updated based on the reception of the purchase request information in step S403.

In a case where the process flow DB 101 is determined to have been updated based on the reception of the purchase request information (Yes in step S403), the enterprise resource planning system 100 determines whether or not the data received in step S401 is information requiring the other processes in step S405.

On the other hand, in a case where the update of the process flow DB 101 is determined not to be based on the purchase request information (No in step S403), the enterprise resource planning system 100 transmits information representing that the process flow DB 101 has been updated to the cooperation server 10 in step S404. In other words, the enterprise resource planning system 100 transmits the business data update information to the cooperation server 10.

When the process flow data update information is transmitted to the cooperation server 10, the enterprise resource planning system 100 determines whether or not the data received in step S401 is information requiring the other processes in step S405.

In a case where the data received in step S401 is determined to be the information requiring the other processes (Yes in step S405), the enterprise resource planning system 100 performs processes according to the content of the data in step S406. When the processes according to the content of the data are executed, the enterprise resource planning system 100 returns to step S401 and waits until data requiring an update of the process flow DB is input.

Here, “the information requiring the other processes”, for example, is information requiring a shipment instruction for a delivery company, information representing that a predetermined product has been shipped, or the like. For example, in a case where the information requiring a shipment instruction for a delivery company is received in step S401, the enterprise resource planning system 100 executes a process of transmitting the shipment instruction to a terminal managed by the delivery company that is a shipment source. In addition, for example, in a case where data representing that a predetermined product has been shipped is received in step S401, the enterprise resource planning system 100 decreases a stock quantity included in the stock information by a shipped quantity so as to update the stock quantity.

Here, “the process of a case where the information representing that a predetermined product has been shipped is received in step S401” that is executed as the other process will be described in detail. In this process, the core business system 100 specifies the “item ID” and the “quantity” by referring to the “common data section”. Thereafter, the core business system 100 specifies stock information corresponding to the specified item ID by referring to the stock information storage unit. Then, the core business system 100 decreases the “actual stock quantity” and the “quantity in process of received order” stored in the stock information by the “quantity” specified as above so as to update the actual stock quantity and the quantity in process of received order. As above, the process of a case where the information representing that a predetermined product has been shipped is received in step S401 is executed.

On the other hand, in a case where the data input in step S401 is determined to be data not requiring the other process (No in step S405), the enterprise resource planning system 100 is returned to step S401 and waits until data requiring an update of the process flow DB is input.

As described above, in the first embodiment described above, a cooperation server that cooperates an EC site selling products on the Internet by referring to a product data storage unit (the product data DB 16) storing data of the products and a plurality of core business systems supplying products to the EC site with each other includes a cooperation data storage unit (the cooperation DB 15) storing cooperation data configured based on business data transmitted from each of the core business systems (the enterprise resource planning system 100, 200, 300) including a business data storage unit (the process flow DB 101) storing the business data generated on business and is configured to receive business data updated content information representing an updated content of the business data from the core business system when the business data is updated by the core business system, update the cooperation data based on the received business data updated content information and execute a process for updating the product data such that the updated content of the business data is reflected when the cooperation data is updated. According to such a configuration, an EC system that can be easily built by using the data managed by the core business system can be provided. In addition, since the updated information of the core business system side can be reflected on the entire EC system in real time, a user reading the EC site can read information having high accuracy. Furthermore, in a case where information is updated on the core business system side, a particular operation for changing information displayed on the EC site is not required, and accordingly, in an EC system built based on the information managed by the core business system, the load of a supervisor of the core business system side can be reduced.

In addition, in the first embodiment described above, when a purchase request of a product is received from a user using the EC site, the cooperation server is configured to update the cooperation data according to a content of the purchase request and transmit purchase request information representing that the purchase request is received to the core business system. According to such a configuration, since the updated information generated at the EC site can be reflected on the entire EC system in real time, a user reading the EC site can read information having high accuracy.

Furthermore, in the first embodiment described above, the core business system includes a business data DB (the process flow DB 101). The business data (the process flow data) stored in the business data DB is configured to be data configured by at least one or more tables, be data configured by the tables that have the same structure, and be data acquired by arranging process data representing data relating to each business process configuring a process flow in same entries of the tables. According to such a configuration, since the number of tables included in the business data can be suppressed to be minimal, the amount of data required for building the EC site can be reduced.

In addition, as described in the first embodiment described above, the core business system is configured to include at least two or more of the business data DBs, further include a replica data reception means for receiving replica data of each of the at least two or more business data DBs, and is configured to update a cooperation DB as the cooperation data storage means based on data acquired by integrating the received replica data. According to such a configuration, also in a case where there are a plurality of DBs storing the business data, by managing the business data as data acquired by arranging a plurality of pieces of the business data into one, the number of programs used for data management is decreased. Therefore, the required amount of data can be reduced, and a case where an EC system in which another core business system is included is to be built can be responded in a flexible manner.

Furthermore, in the first embodiment described above, the cooperation server is configured to update the cooperation DB such that data acquired by directly integrating a plurality of pieces of the received replica data is set as the cooperation data. According to such a configuration, in a case where an EC system is built by handling a plurality of pieces of business data stored in the core business system, the EC system can be built by employing a simple configuration.

In addition, as described in the first embodiment described above, the cooperation server may be configured to update a cooperation DB such that data at least including process data corresponding to a display item displayed on the EC site is set as the cooperation data. According to such a configuration, the data configuring the table can be reduced. Accordingly, the system can be easily built, and the amount of data required for building the EC site can be reduced.

Furthermore, as described in the first embodiment described above, the core business system of the system may be configured to include a stock information storage unit that stores stock information including an item ID uniquely specifying a product, a core business system ID uniquely specifying a core business system thereof, a stock quantity, and the number of orders and update the stock information when information representing shipment as the business data update information is received. More specifically, the core business system may be configured to determine whether or not the information requiring the update of the process flow data received in step S401 in the business data update process described above is information representing that a product has been shipped and update the stock quantity included in the stock information when the information is determined to represent that the product has been shipped. According to such a configuration, since provisional stock information representing provisional stock information at the time of receiving an order and actual stock information representing the actual stock information can be managed in a separated manner, accurate information can be handled.

In addition, while not particularly mentioned in the first embodiment described above, the cooperation server 10 may be configured to receive actual stock information from the core business system at predetermined timing, determine whether or not the received actual stock information and the provisional stock information included in the product data have values coinciding with each other, and transmit an alert to the core business system in a case where the values are determined not to coincide with each other. In addition, the core business system to which the alert has been transmitted displays a content of the alert on a display device included therein. According to such a configuration, a notification of a trouble that is based on stock mismatching can be made in advance, and, the core business system side for which the notification has been made can take a measure for configuring accurate information.

As above, the EC system according to the first embodiment has been described. Next, an EC system according to a second embodiment will be described.

### Second Embodiment

In the EC system 500 according to the first embodiment, the cooperation server 10 is configured to serve also as a server that manages the EC site. In an EC system 600 according to a second embodiment, a server other than the cooperation server 10 is configured to manage the EC site. More specifically, an EC site management server 30 is configured to serve as the server that manages the EC site. Hereinafter, in a case where a configuration that is the same as that of the system 500 according to the first embodiment described above is included, the description thereof will be presented using the same reference numeral, and detailed description thereof will not be presented.

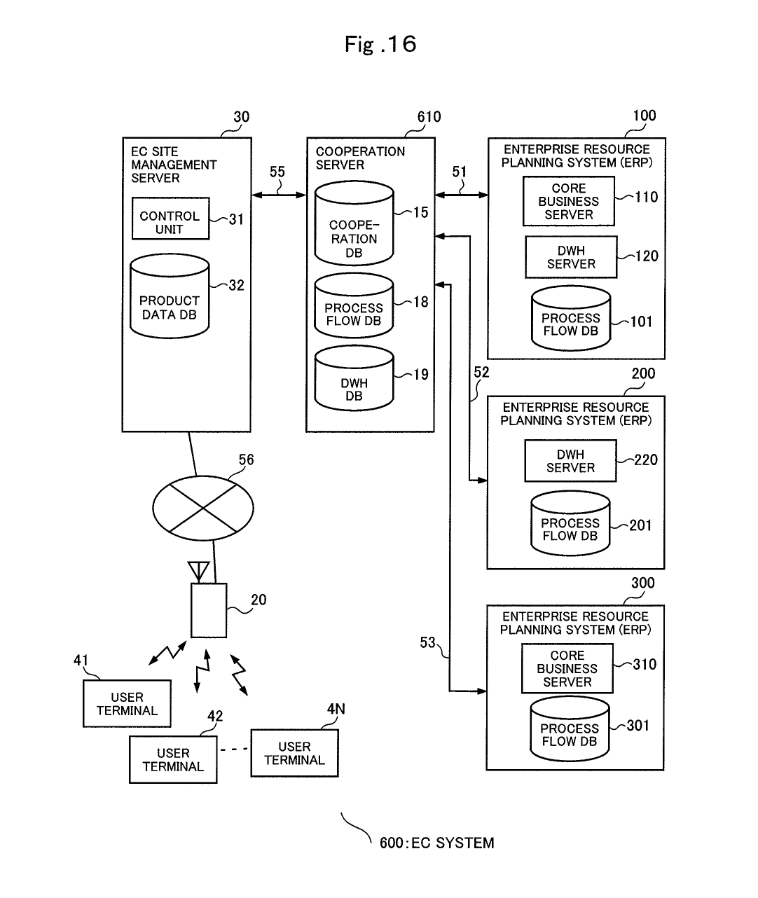

FIG. 16 is a block diagram that illustrates an example the configuration of the EC system 600 according to the second embodiment of the present invention. As illustrated in FIG. 16, the EC system 600 includes a cooperation server 610, an EC site management server 30, a repeater 20, user terminals 41 to 4N (here, N is an arbitrary positive integer), and enterprise resource planning systems 100, 200, and 300.

The EC site management server 30 is a server that provides various kinds of data through a communication network 56 in response to requests from the user terminals 41 to 4N used by users. The EC site management server 30, for example, is configured by an information processing apparatus such as a WWW server and is managed by a supervisor of the EC site.

As illustrated in FIG. 16, the EC site management server 30 includes a control unit 31 that performs various control processes, a product data DB 32, a transaction data DB 33, a DB that stores a control program used for configuring the EC site. In other words, the EC site management server 30 according to the second embodiment includes configurations corresponding to the product data DB 16 included in the cooperation server 10 according to the first embodiment and the EC site management processing unit 11d.

The control unit 31 included in the EC site management server 30 executes various processes used for managing the EC site. Particularly, among various processes executed by the cooperation server 10 according to the first embodiment inside therein, processes such as the process of receiving requests from the user terminals 41 to 4N, the process of generating various kinds of data (for example, the EC page and the product data), the process of updating various kinds of data (for example, the product data), the process of transmitting various kinds of data to the user terminals 41 to 4N, and the process of transmitting various kinds of data (various kinds of information) to the cooperation server 10 are executed.

The product data DB 32 is a storage medium that stores product data used for configuring the EC site. Here, the product data includes at least information relating to the stock. In addition, although not particularly illustrated in the figure, in this example, the product data includes an item ID, a core business system ID, a stock quantity, and a status. In addition, the product data relating to the second embodiment is generated by the EC site management server 30 based on cooperation data transmitted from the cooperation server 610.

The transaction data DB 33 is a storage medium that stores transaction data configuring the EC site.

Next, an EC site update process that is executed by the cooperation server 610 of the system 600 of this example will be described.

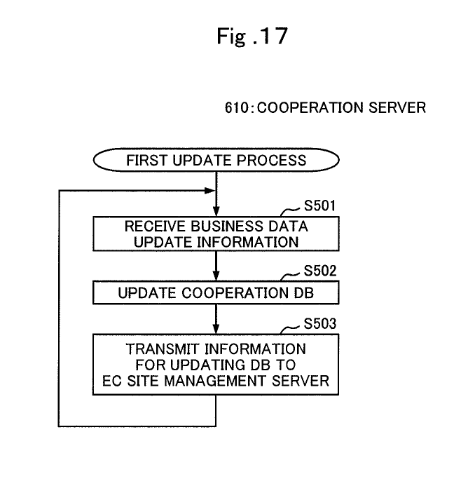

FIG. 17 is a flowchart that illustrates an example of the first update process executed by the cooperation server 610 of the system 600 of this example. In the first update process, while various kinds of data is transmitted from each core business system, in the first update process to be described below, a case will be described as an example in which data is transmitted from the enterprise resource planning system 100. In this example, while the cooperation server 610 is operated, the process is assumed to be looped.

In the first update process, first, the cooperation server 610 receives business data update information representing that the enterprise resource planning system 100 has updated the process flow DB 101 from the enterprise resource planning system 100 in step S501.

When the business data update information is received, the cooperation server 610 updates the cooperation DB 15 based on the received business data update information in step S502.

When the cooperation DB 15 is updated, the cooperation server 610 transmits information used for updating the DB (for example, the product data DB, the transaction data DB, or the like) managed by the EC site management server 30 according to the content of the update to the EC site management server 30 in step S503. Here, the “information used for updating a DB managed by the EC site management server 30” is information used for determining a DB to be changed and a change to be made therein. More specifically, the above-described information is instruction information in which an update place is represented based on the information (for example, information such as the “status” or the “orderer”) stored in the table added to the cooperation data.

When the information used for updating the DB is transmitted to the EC site management server 30, the cooperation server 610 proceeds to step S501 and waits until the business data update information is received. In addition, in the EC site management server 30, an update process for updating the product data DB 32 is executed based on the information used for updating the DB.

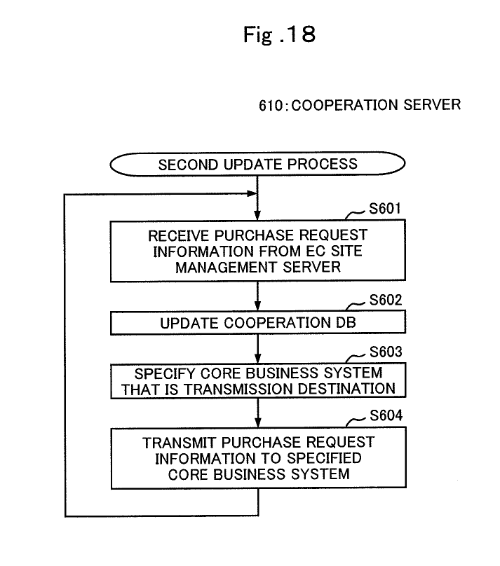

Next, an example of a second update process executed by the cooperation server 610 in the system 600 of this example will be described. FIG. 18 is a flowchart that illustrates an example of the second update process executed by the cooperation server 610 in the system 600 of this example. In the second update process, a case will be described as an example in which a product purchase request is transmitted from the EC site management server 30.

In the second update process, first, the cooperation server 610 receives the purchase request information from the EC site management server 30 in step S601. In addition, in this example, when the product purchase request is received from the user terminal 41, the EC site management server 30 updates the product data DB 32 based on the purchase request information and transmit the purchase request information to the cooperation server 610.

When the purchase request information is received, the cooperation server 610 stores the purchase request information in the transaction data DB 33 and updates the cooperation DB according to the content of the purchase request information in step S602.

When the cooperation DB is updated, the cooperation server 610 specifies a core business system corresponding to the purchase request information in step S603.

When the core business system corresponding to the purchase request is specified, the cooperation server 610 transmits the purchase request information to the specified core business system in step S604.

When the purchase request information is transmitted, the cooperation server 610 proceeds to step S601 and waits until the purchase request information is received.

As described above, the EC system of this example may be a system that is configured by the EC site management server that manages the EC site selling products on the Internet by referring to the product data storage unit (the product data DB 32) storing data of products; the core business system that supplies products for the EC site; and the cooperation server that cooperates the EC site management server and the core business system with each other.

In addition, each of the cooperation server 10 and 610 performs each process described above according to a processing program stored in a storage unit thereof.

In addition, the transaction data stored in each of the transaction data DBs (14 and 33) described above may be integrally configured with the product data stored in each of the product data DBs (15 and 32).

### INDUSTRIAL APPLICABILITY

The present invention is useful for building an EC system using a core business system.

### REFERENCE SIGNS LIST

10 and 610 Cooperation server
20 Repeater
30 EC site management server
41 to 4N User terminal
51 to 56 Communication network
100, 200, and 300 Enterprise resource planning system
110 Core business server
120 DWH server
500 and 600 EC system

1. A cooperation server that cooperates an EC site selling products on the Internet by referring to a product data storage means for storing data of the products and a plurality of core business systems supplying products to the EC site with each other, the cooperation server comprising:
a cooperation data storage means for storing cooperation data configured based on business data transmitted from each of the core business systems including a business data storage means for storing the business data generated on business;
an updated content information reception means for receiving business data updated content information representing an updated content of the business data from the core business system when the business data is updated by the core business system;
a first cooperation data update means for updating the cooperation data based on the received business data updated content information; and
a product data update processing means for executing a process for updating the product data such that the updated content of the business data is reflected when the cooperation data is updated.

2. The cooperation server according to claim 1, further comprising:
a second cooperation data update means for updating the cooperation data according to a content of a purchase request when the purchase request of a product is received from a user using the EC site; and
a purchase request information transmission means for transmitting purchase request information representing that the purchase request is received to the core business system.

3. The cooperation server according to claim 1, wherein
the core business system includes a business data DB as the business data storage means, and
the business data stored in the business data DB is data configured by at least one or more tables, is data configured by the tables that have the same structure, and is data acquired by arranging process data representing data relating to each business process configuring a process flow in same entries of the tables.

4. The cooperation server according to claim 3, wherein the core business system includes at least two or more of the business data DBs and further includes a replica data reception means for receiving replica data of each of the at least two or more business data DBs and a first cooperation DB update means for updating a cooperation DB as the cooperation data storage means based on data acquired by integrating the received replica data.

5. The cooperation server according to claim 4, wherein the first cooperation DB update means updates the cooperation DB such that data acquired by directly integrating a plurality of pieces of the received replica data is set as the cooperation data.

6. The cooperation server according to claim 3, further comprising a second cooperation data update means for updating a cooperation DB as the cooperation data storage means such that data at least including process data corresponding to a display item displayed on the EC site is set as the cooperation data.

7. The cooperation server according to claim 1, wherein
the product data update processing means updates the product data by transmitting the business data updated content information to the EC site management server managing the EC site, and
the EC site management server includes:
the product data storage means; and
an EC page generation means for generating an EC page configuring the EC site by referring to the product data storage means.

8. The cooperation server according to claim 1, wherein
a server managing the EC site is the cooperation server, and
a server including the product data storage means is the cooperation server.

9. A cooperation program used for controlling a cooperation server that cooperates an EC site selling products on the Internet by referring to a product data storage means for storing data of the products and a plurality of core business systems supplying products to the EC site with each other, the cooperation program causing the cooperation server including a cooperation data storage means for storing cooperation data configured based on business data transmitted from each of the core business systems including a business data storage means for storing the business data generated on business to execute:
an updated content information reception process for receiving business data updated content information representing an updated content of the business data from the core business system when the business data is updated by the core business system;
a first cooperation DB update process for updating the cooperation data based on the received business data updated content information; and
a product data update process for executing a process for updating the product data such that the updated content of the business data is reflected when the cooperation data is updated.

10. An EC system comprising:
an EC site selling products on the Internet by referring to a product data storage means for storing data of the products;
a plurality of core business systems supplying products to the EC site; and
a cooperation server cooperating the EC site and the core business system with each other,
each of the core business systems comprising a business data storage means for storing business data generated on business,
the cooperation server comprising:
a cooperation data storage means for storing cooperation data configured based on business data transmitted from the core business system including the business data storage means;
an updated content information reception means for receiving business data updated content information representing an updated content of the business data from the core business system when the business data is updated by the core business system;
a first cooperation data update means for updating the cooperation data based on the received business data updated content information; and
a product data update processing means for executing a process for updating the product data such that the updated content of the business data is reflected when the cooperation data is updated.
